(19) United States
(12) Patent Application Publication
(10) Pub. No.: US 2005/0070348 A1
(43) Pub. Date: Mar. 31, 2005

(54) Hand-held communication electronic apparatus having two slidable keypads

(75) Inventors: Chin-Fa Lee, Taipei Hsien (TW); Chi-Yu Ho, Taipei Hsien (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/671,540

(22) Filed: Sep. 29, 2003

(51) Int. Cl. H04B 1/00

(52) U.S. Cl. 455/575.4

(57) ABSTRACT

The present invention is to provide a compact and easy-to-use hand-held communication electronic apparatus, which comprises a main housing having a display screen and control keys on the surface thereof, a first sliding keypad being combined with the main housing by means of a first rail, so that the first sliding keypad not only can be stored behind and parallel to the main housing, but also can be slid out from the bottom of the main housing; a second sliding keypad is combined with the first sliding keypad by means of a second rail, so that the second sliding keypad not only can be stored behind and parallel to the first sliding keypad, but also can be slid out from the side of the main housing.

### BACKGROUND OF THE INVENTION

1. Field of the Invention

The present invention relates a hand-held communication electronic apparatus, more particularly to a compact and easy-to-use hand-held communication electronic apparatus having two sliding keypads slidably stored behind and parallel to a main housing of the apparatus, which can be slid out from the bottom and side of the main housing respectively.

2. Prior Art of the Invention

The original intention to design mobile phone is mainly for a user to communicate with other people at any time. The original design objective of a personal digital assistant (hereinafter referred to as PDA) is to provide a user with a plurality of electronic personal information management (abbreviated as PIM) tools of the functions similar to a personal schedule management, a notebook and a telephone pad etc., that is the reason why PDA is also called as an electronic organizer. However, while the personal computer and communication apparatus being combined together within the recent years, a smart phone is then designed to combine cell phone with PDA functions, which not only be used as a mobile communication tool in speech communication, but also provided with the functions of personal information management, receiving electronic mails, reading electronic news, or downloading information from internet. Therefore, the smart phones are now becoming one of the most popular electronic products.

This kind of smart hand-held electronic apparatus has a display screen, a plurality of keys and an output/input port, which can transmit and exchange data with a computer by means of a communication interface. Hence, there are a variety of interesting computer games being developed and provided in the internet for consumers to download. However, since the design of current electronic products tends to make them more lighter, thinner, shorter and smaller, the dimension of the display screen on the product is seriously limited and the size of keypad on the housing thereof is also deducted within a limited area. Thus, it is harmful to the user's eyes who uses such a small display screen on the smart hand-held electronic apparatus to play computer games and receive electronic mails from internet.

Therefore, how to design a compact and easy-to-portable hand-held wireless communication electronic apparatus not only having two stored keypads, but also having a display screen of an appropriate size is a very important topic in the field that needs to be resolved immediately.

### SUMMARY OF THE INVENTION

The present invention is to provide a compact and easy-to-use hand-held communication electronic apparatus, which not only has two stored keypads, but also has a display screen with an appropriate dimension for watching. An object of the present invention is to increase the value of the electronic apparatus through applying the characteristics disclosed in the present invention for matching the consumers' needs within the vast and competitive market. The characteristics of the present invention refer to a hand-held electronic apparatus having a display screen and a set of control keys on the surface of a main housing thereof, and a first sliding keypad and a second sliding keypad stored in the main housing, wherein the first sliding keypad is slidably combined with the main housing by means of a first rail so that the first sliding keypad can be stored behind and parallel to the main housing and slid out from the bottom of the main housing in one direction, and the second sliding keypad is slidably combined with the first sliding keypad by means of a second rail so that the second sliding keypad can be stored behind and parallel to the first sliding keypad and the bottom of the first sliding keypad in another direction.

### BRIEF DESCRIPTION OF THE DRAWINGS

The above and other objects, advantages, and features of the present invention will be understood from the following detailed description of the invention when considered in connection with the accompanying drawings below.

FIG. 1 is a perspective view of showing the electronic apparatus of the present invention.

FIG. 2 is a perspective view of showing the electronic apparatus of the present invention having the first keypad being slid out from the bottom of the main housing in one direction.

FIG. 3 is a perspective view of showing the electronic apparatus of the present invention having the second keypad being slid out from the bottom of the first keypad in another direction.

FIG. 4 is a block diagram of the elements and circuits of the present invention.

### DETAILED DESCRIPTION OF THE INVENTION

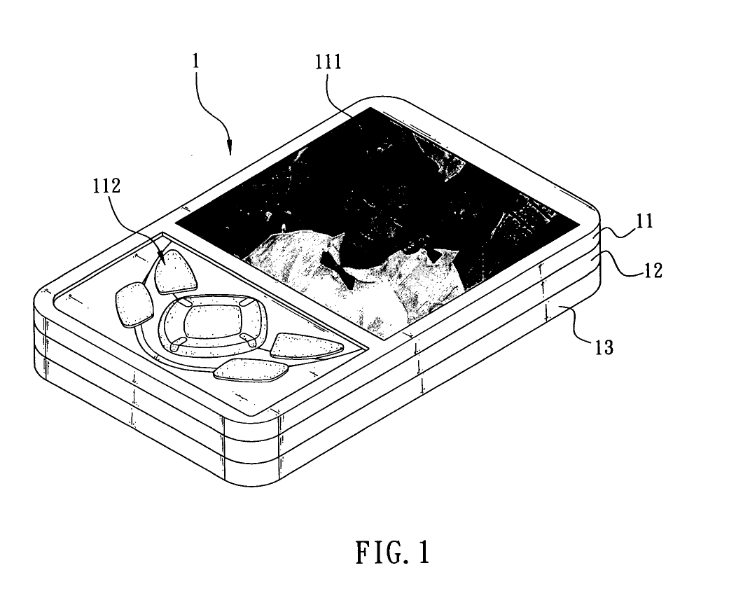

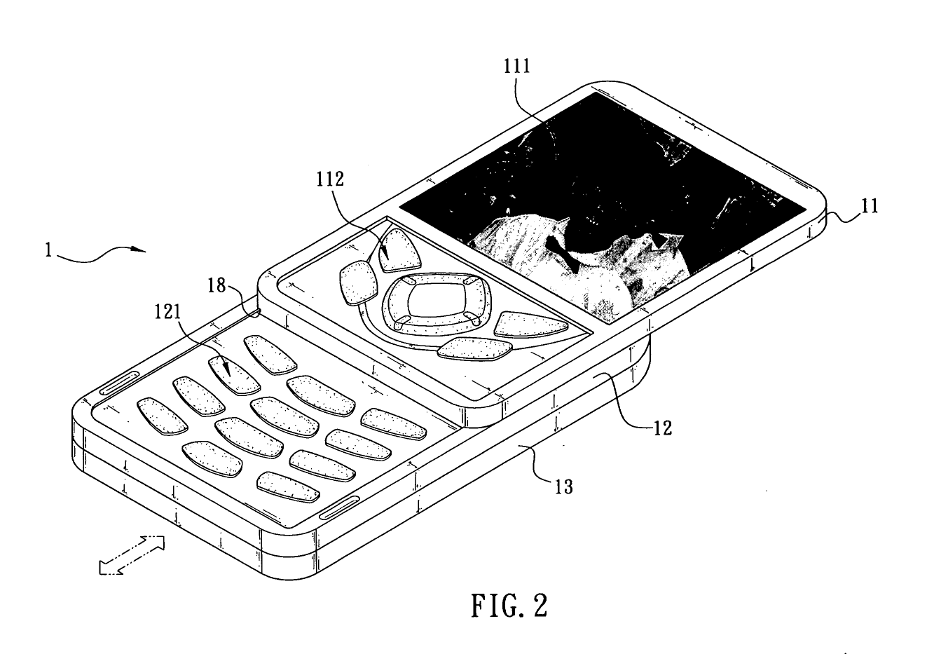

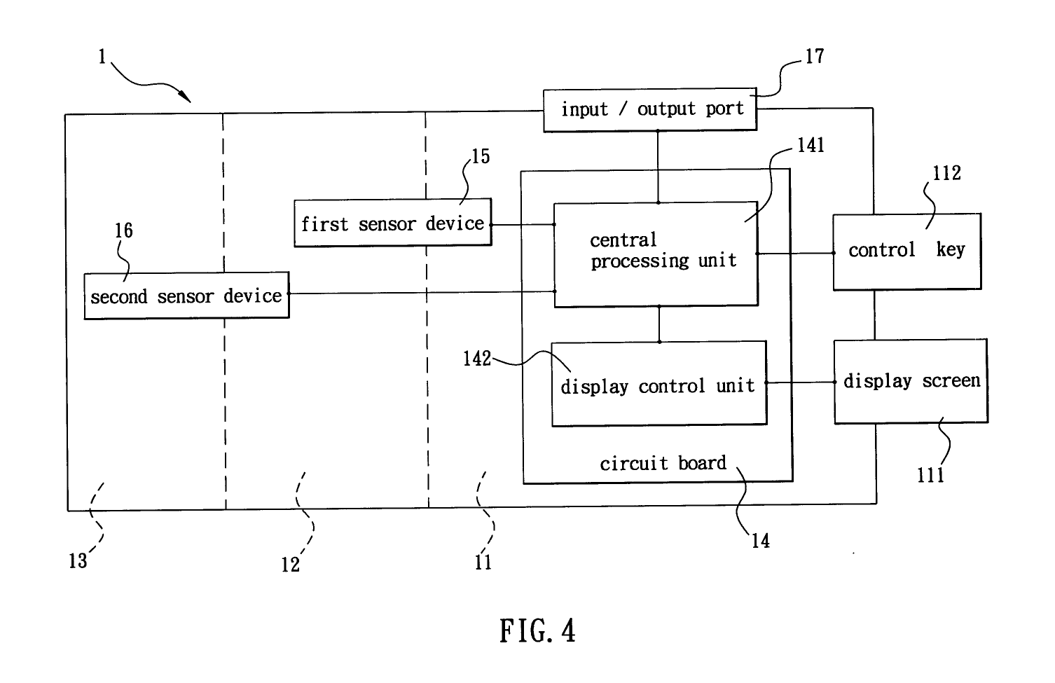

The present invention is a hand-held communication electronic apparatus having two slidable keypads, as referring to FIGS. 1˜4, where the hand-held communication electronic apparatus 1 comprises a main housing 11, a first sliding keypad 12 and a second sliding keypad 13 (as shown in FIG. 1) in a way being sequentially stacked and combined together from top to bottom. The hand-held communication electronic apparatus 1 further comprises a circuit board 14 being installed inside the main housing 11, which is only an embodiment of the present, numerous modifications and variations could be made thereto by those skilled in the art, such as installing the circuit board 14 inside the first sliding keypad 12 or inside the second sliding keypad 13 should be deemed as within the scope and spirit of the present invention. There is a central processing unit 141 being installed on the circuit board 14 for controlling all the electronic elements being operated in a normal condition. As shown in FIGS. 1 and 4, there are a display screen 111 and a set of control keys 112, such as an answering key or a turn-off key, being installed on a surface of the main housing 11. The first sliding keypad 12 is slidably combined with the main housing 11 by means of a first rail 18, so that the first sliding keypad 12 can be stored behind and parallel to the main housing 11 and be slid out a predetermined distance from the bottom of the main housing 11 in one direction to expose a plurality of keys 121 on the first sliding keypad 12, as shown in FIG. 2. The second sliding keypad 13 is slidably combined with the first sliding keypad 12 by means of a second rail 19, so that the second sliding keypad 13 can be stored behind and parallel to the first sliding keypad 12 and be slid out a predetermined distance from the bottom of the first sliding keypad 12 in another direction perpendicular to the said direction to expose a plurality of keys 131 on the second sliding keypad 13.

According to the above-mentioned design, as referring to FIGS. 1˜3, since most of the keys 121 and 131 are installed on the first and second sliding keypads 12 and 13, there are only few important control keys needed to be installed on the the main housing 11. This not only effectively increases the space on the main housing 11 for installing the display screen 111 of a larger dimension or size, but also provide a more comfortable and convenient environment for a user to watch information or play game on the display screen 111. In addition, while the user wants to use the hand-held communication electronic apparatus 1 to answer the phone, he only needs to press the answering key (one of the control keys 112) to go talking. As user wants to use the hand-held communication electronic apparatus 1 to call out or transmit a message, he just needs to pull the first sliding keypad 12 out from the bottom of the main housing 11 and press the keys 121 on the first sliding keypad 12 for inputting the numbers and messages. Furthermore, when the user wants to use the hand-held communication electronic apparatus 1 to process or manage more complicate information or documents, he only needs to pull the second sliding keypad 13 out from the bottom of the first sliding keypad 12 in another direction, enabling him to use the keys 131 on the second sliding keypad 13 for inputting the data and processing documents through cooperating with the display screen 111.

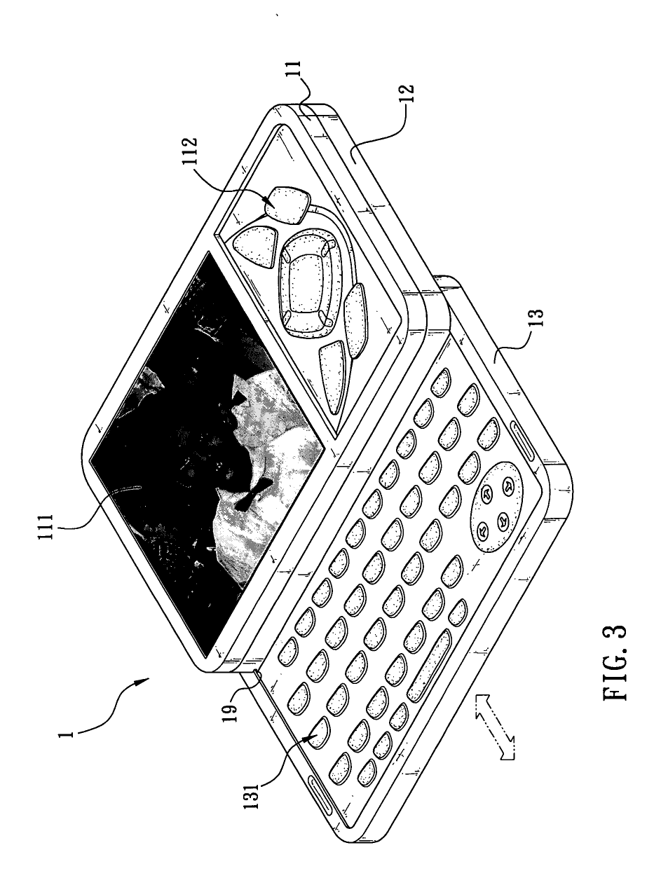

In the present invention, as referring to FIG. 4, the circuit board 14 has a display control unit 142 connecting to the central processing unit 141. The display control unit 142 controls the image and the direction thereof shown on the display screen 111. In addition, a first sensor device 15 is installed between the main housing 11 and the first sliding keypad 12, and the first sensor device 15 is connected to the central processing unit 141. A second sensor device 16 is installed between the second sliding keypad 13 and the first sliding keypad 12, and the second sensor device 16 is also connected to the central processing unit 141. Therefore, when a user pulls the first sliding keypad 12 out from the bottom of the main housing 11 in one direction, as shown in FIG. 2, the first sensor device 15 would be trigged and then transmits a command to the central processing unit 141. The central processing unit 141 then sends a control signal to the display control unit 142 to adjust the image and the direction thereof shown on the display screen 111 in cooperating with the operation direction of the first sliding keypad 12. For the same reason, while the user pulls the second sliding keypad 13 out from the bottom of the first sliding keypad 12 in another direction, as shown in FIG. 3, the second sensor device 16 would be trigged and then transmits another command to the central processing unit 141. The central processing unit 141 then sends another contrl signal to the display control unit 142 to adjust the image and the direction thereof shown on the display screen 111 in cooperating with the operation direction of the second sliding keypad 13, of which the angle is perpendicular to the operation direction of the first sliding keypad 12 in this embodiment.

In the present invention, as referring to FIGS. 1˜4, the hand-held electronic apparatus 1 may be a mobile phone or a smart phone through combining a personal digital assistant with a mobile phone. On an appropriate position of the main housing 11, there may be installed at least one input/output port 17 (as shown in FIG. 4), e.g. a universal serial bus port, also called USB port. The first sliding keypad 12 may be a keypad that matches the CTITT standard (general called CCITT keypad), and the second sliding keypad 13 may be a keypad that matches the standard keys (called QWERT keypad).

Summing up the above, since the keypads of the hand-held communication electronic apparatus 1 disclosed in the present invention are no longer directly installed on the surface of the main housing 11, the space on the main housing 11 for installing the display screen 111 are effectively increased to provide a more comfortable and convenient environment for a user to watch information or play game on the display screen 111.

While a preferred embodiment of the invention has been shown and described in detail, it will be readily understood and appreciated that numerous omissions, changes and additions may be made without departing from the spirit and scope of the invention.

1. A hand-held communication electronic apparatus having two slidable keypads comprises:
a circuit board having a central processing unit, which locates in an appropriate position inside said electronic apparatus;
a main housing whose surface has a display screen connecting to said circuit board and a plurality of control keys;
a first sliding keypad which is combined with said main housing by means of a first rail enabling said first sliding keypad to be stored behind and parallel to said main housing and be slid out from the bottom of said main housing in one direction to expose keys located on said first sliding keypad;
a second sliding keypad which is combined with said first sliding keypad by means of a second rail enabling said second sliding keypad to be stored behind and parallel to said first sliding keypad and be slid out from the bottom of said first sliding keypad in another direction other than said direction to expose keys located on said second sliding keypad.

2. The hand-held communication electronic apparatus according to claim 1, wherein said circuit board has a display control unit which controls the image and the direction thereof shown on said display screen.

3. The hand-held communication electronic apparatus according to claim 2, wherein a first sensor device is installed between said main housing and said first sliding keypad and is connected to said display control unit for sending a control signal to said display control unit to adjust the image and the direction thereof shown on said display screen in cooperating with the operation direction of said first sliding keypad while said first sliding keypad being pulled out from the bottom of said main housing.

4. The hand-held communication electronic apparatus according to claim 2, wherein a second sensor device is installed between said first sliding keypad and said second sliding keypad and is connected to said display control unit for sending another control signal to said display control unit to adjust the image and the direction thereof shown on said display screen in cooperating with the operation direction of said second sliding keypad while said second sliding keypad being pulled out from the bottom of said first sliding keypad.

5. The hand-held communication electronic apparatus according to claim 1, wherein said hand-held communication electronic apparatus could be a mobile phone.

6. The hand-held communication electronic apparatus according to claim 1, wherein said hand-held communication electronic apparatus could be a personal digital assistant having communication functions of a mobile phone.

7. The hand-held communication electronic apparatus according to claim 1, wherein said first sliding keypad matches the requirement of the CCITT keypad standard.

8. The hand-held communication electronic apparatus according to claim 1, wherein said second sliding keypad could be a standard keypad.

9. The hand-held communication electronic apparatus according to claim 1 further comprising at least one output/input port at an appropriate position on said main housing.

10. The hand-held communication electronic apparatus according to claim 9, wherein said output/input port matches universal serial bus specification and is connected to said central processing unit.
